(19) United States
(12) Patent Application Publication
(10) Pub. No.: US 2004/0004032 A1
(43) Pub. Date: Jan. 8, 2004

(54) Process for wet screening fibrous suspensions

(75) Inventors: Ralf Burger, Bohmenkirch (DE); Werner Lange, Auernheim (DE); Gerhard Veh, Hochstadt (DE); Samuel Schabel, Darmstadt (DE); Geoffrey G. Duffy, Auckland (NZ)

Correspondence Address: GREENBLUM & BERNSTEIN, P.L.C., 1950 ROLAND CLARKE PLACE, RESTON, VA, 20191, US

(73) Assignee: Voith Paper Patent GmbH, Heidenheim (DE)

(21) Appl. No.: 10/419,868

(22) Filed: Apr. 22, 2003

(30) Foreign Application Priority Data
Apr. 23, 2002 (DE) 102 17 926.3

(51) Int. Cl. B07B 1/00

(52) U.S. Cl. 209/233

(57) ABSTRACT

Process and apparatus for wet screening fibrous suspensions with a screen having a plurality of screen openings. The process includes guiding a portion of the fibrous suspension passing through the plurality of screen openings, which are formed as long holes having widths of between 1 and 8 mm, as accepted stock, and guiding a portion of the fibrous suspension not passing through the long holes separately from the accepted stock as rejected material. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of German Patent Application No. 102 17 926.3, filed on Apr. 23, 2002, the disclosure of which is expressly incorporated by reference herein in its entirety.

### BACKGROUND OF THE INVENTION

1. Field of the Invention

The invention relates to a process for the wet screening of fibrous suspensions using a screen with a plurality of screen openings, through which accepted stock of the fibrous suspension passes and from which rejected material is guided away.

2. Discussion of Background Information

An important use of such processes is the screening of fibrous suspensions in pressurized screens. The fibers contained in the suspension are thereby to pass through the screen as accepted stock, whereas the undesirable solid components are rejected and guided out of the pressurized screen again as overflow fraction. In addition to the good screening effect, a high throughput through the screen device is important in order to be able to carry out the screening process in an economic manner. The throughput is usually thereby stated relative to the open free screen surface in order to quantify the relevant property of the screen. Analogously to this, the screen pass-through speed can also be stated, which is calculated from the volume throughput and the sum of the perforated surfaces.

When carrying out a process of this kind, in almost every case a scraper is moved closely past the surface of the screen in order to remove the rejected material from the intake area of the screen openings. Scrapers also usually produce pressure surges and/or suction surges. Due to the suction surges the flow direction in the screen opening temporarily reverses, so that fiber accumulations or particles that cannot pass through it are conveyed back again against the normal flow-through direction.

Screens with a cylindrical shape are called screen baskets. However, there are also flat screens that serve the same purpose.

Even though all screens that are used for screening fibrous suspensions fundamentally work according to the same principle, very great differences exist in the embodiment of the screen openings. This is because different demands have to be met, depending on the degree of slushing of the paper fiber pulp and depending on the fineness of the solid matter to be screened out that is entrained by it. The screen openings thereby differ not only with regard to their size, but also with regard to their shape. With screens for screening fibrous suspensions for a long time there has therefore been the fundamental distinction between screens with holes and screens with slots. It has turned out that screens with holes are particularly favorable for the coarse screening of fibrous suspensions, permitting high throughputs with relatively high consistency. Primary screening is carried out with fibrous suspensions in which the screenable contaminants have a proportion of at least 0.3%. However, screens with slots are optimal for fine screening, due to the fact that the paper fibers that pass through the screen in such screening processes have an oblong shape, whereas a large part of the impurities to be rejected are cubic or flat. In selecting a suitable screen, the demands for a high throughput and the required screening quality have to be weighed up. Examples of a screen basket with holes are shown in German Patent Application No. DE 196 35 189 and for a screen basket with slots in German Patent Application No. DE 39 27 748 A1.

A screen basket is known from German Patent Application No. DE 198 15 449 A1 that is provided with relatively narrow slots and thus essentially intended for fine screening. Unlike the usual screen baskets with slots, these slots do not run over the entire axial extent of the screen basket, but are subdivided several times. This is designed to improve the screening quality of the screen basket with slots. Screen baskets of this type are specifically optimized for the removal of materials that are very difficult to screen out, e.g., stickies. As a rule, this is achieved at the cost of a relatively low throughput, relative to the entire screen surface. Moreover, screens of this type require a relatively low consistency. It should be below 2.5%, if possible about 1.5%. It is different with screens with holes, which can be operated effectively and reliably even with a consistency of about 3% and above.

The screen baskets known from European Patent Application No. EP 0 455 312 A2 are also evidently intended for fine screening. Concrete data for preferred examples are for slot widths of clearly under 1 mm. Although other data are also found at other places in the document, e.g., “0.002 inch to 0.35 inch or more,” i.e., 0.05 mm to 9 mm or more, this is a wider range and nothing is said about which selection should be made for which application cases. The publication primarily describes processes for producing slots or holes the shape and size of which are favorable for certain applications. In this connection it is also explained that the new production process provides the possibility of also producing unusual shapes of screen openings, for which a number of examples are listed.

German Patent Application No. DE 297 14 914 U1 shows screens that are intended for rejects screening. Therefore, they are not installed in a pressurized screen, but in a screen device that features an air space in the intake chamber in order to be able to form an intensely thickened fiber-free reject.

### SUMMARY OF THE INVENTION

The present invention provides processes for screening fibrous suspensions so that the throughput can be increased without significant losses of screening quality.

The present invention is directed to a process that utilizes a screen with screen openings formed as long holes with a hole width of between 1 and 8 mm. Preferably the hole width is between 1 and 3 mm.

Furthermore, it has been established that with screens used according to the invention the long fiber content in the screen throughput (accepted stock) is increased as compared with traditional screens with holes. The new process can therefore also work with a better discrimination. Moreover, a clearly larger amount can be screened without forfeiting quality.

The present invention is directed to a process for wet screening fibrous suspensions with a screen having a plurality of screen openings. The process includes guiding a portion of the fibrous suspension passing through the plurality of screen openings, which are formed as long holes having widths of between 1 and 8 mm, as accepted stock, and guiding a portion of the fibrous suspension not passing through the long holes separately from the accepted stock as rejected material.

In accordance with a feature of the invention, the widths of the long holes can be between 1 and 3 mm. Preferably, the widths can be at least 1.5 mm.

According to another feature of the instant invention, the long holes can have a length of between 1 and 50 mm. Preferably, the length is between 2 and 5 mm.

In accordance with still another feature, a ratio of hole length to hole width may be between 2 and 20. The ratio can be between 2 and 10.

Further, a spacing between adjacent long holes in a direction of longitudinal extension can be between 1 and 6 mm.

The process can also include clearing the screen by moving a scraper past the screen. The scraper can be moved in a direction so that an angle between a longitudinal direction of the long holes and the scraper moving direction is between 0 and 75°.

Moreover, the screen can be formed as a cylindrical screen basket. The longitudinal extension direction of the long holes can be oriented at an angle between 15° and 90° to an axial direction of the screen basket. The angle may be larger than 45°. Further, the angle is 90°.

In accordance with a further feature of the present invention, the fibrous suspension can have a consistency of at least 2%, and preferably the fibrous suspension consistency is at least 3%.

Still further, the fibrous suspension may include a content of screenable contaminants of at least 0.3%, and the screenable contaminants content can be at least 0.5%.

According to a still further feature of the invention, the fibrous suspension can include slushed recovered paper.

In accordance with still another feature of the present invention, the screen can be structured and arranged as a pressurized screen.

A plurality of screens can be arranged to screen the fibrous suspension and at least one of the plurality of screens may be structured and arranged as a pressure screen. The rejected material can include a suspension enriched with contaminants, and the process may further include removing the rejected material from the pressurized screen.

The present invention is directed to an apparatus for wet screening fibrous suspensions. The apparatus includes at least one screen formed with a plurality of elongated holes having a length greater than a width, in which the at least one screen is arranged to separate accepted portions of the fibrous suspension passing through the at least one screen from rejected materials not passing through the at least one screen. The width of the elongated holes is between 1 and 8 mm.

According to a feature of the invention, the apparatus can also include a scraper arranged for movement adjacent an inlet side of the at least one screen. A longitudinal extent of the elongated holes can be oriented at an angle between 0 and 75° to a moving direction of the scraper.

The screen may be formed as a cylindrical screen basket, and a longitudinal extension of the elongated holes may be oriented at an angle between 15° and 90° to an axial direction of the screen basket. The angle can be larger than 45°. Further, the angle may be 90°.

According to the invention, the widths of the elongated holes may be between 1 and 3 mm, and, preferably, the widths may be at least 1.5 mm.

Still further, the elongated holes can have a length of between 1 and 50 mm. Preferably, the length may be between 2 and 5 mm.

A ratio of hole length to hole width can be between 2 and 20. further, the ratio may be between 2 and 10.

According to another feature of the invention, a spacing between adjacent elongated holes in a direction of longitudinal extension may be between 1 and 6 mm.

In accordance with still yet another feature of the present invention, the at least one screen can be structured and arranged as a pressurized screen.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a principle of the process using a cylindrical screen basket;

FIG. 2 illustrates screen openings formed in accordance with the invention; and

FIG. 3 illustrates a part of another suitable screen.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

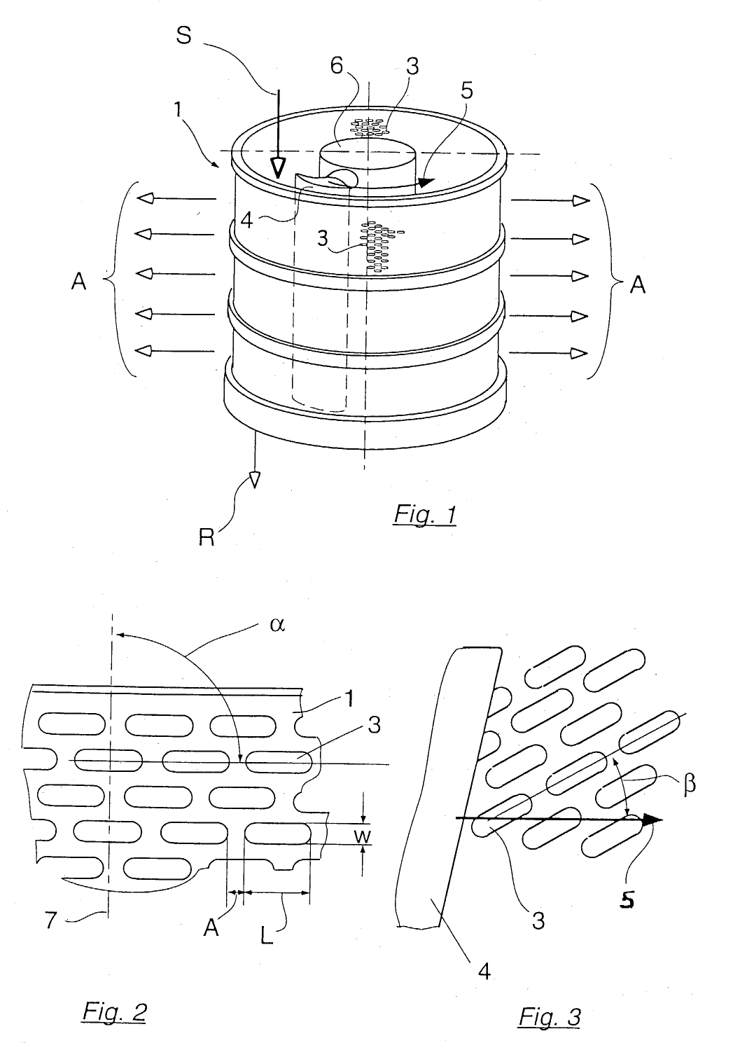

As FIG. 1 shows by way of example, the screen 1 used to carry out the process can be embodied or formed as a cylindrical screen basket (perspective drawing). It is crucial for the process that screen openings 3 are embodied or formed as long holes. While only a few long holes are shown in the accompanying illustrations, it is known that screen baskets can include thousands of such screen openings. In order to carry out the wet screening of a fibrous suspension S in the exemplary embodiment, fibrous suspension S is fed from above into an interior of the screen basket. A portion of fibrous suspension S can pass through screen openings 3 as accepted stock A, and another portion of fibrous suspension S, which is made up at least in part of materials rejected at screen openings 3, is guided out of screen 1 below as reject R. Naturally, with technical execution of the process, a housing accommodating screen 1 is available, e.g., to support screen 1 and to guide suspension streams S in a suitable manner. Since such pressurized screens are sufficiently known, there is no representation of the housing.

As already mentioned, in most cases screen 1 is kept clear with at least one scraper 4 being moved past screen 1 in direct proximity to it. Scraper 4, which is depicted in this embodiment with blade profiles, can be formed with other shapes. Moreover, while only one such scraper 4 is depicted, additional scrapers can be utilized without departing from the scope of the present invention. Scraper 4 is driven by a central shaft 6 to move past an inside surface of screen 1 in a movement direction indicated by arrow 5. Therefore, a scraping on an intake side of screen 1 occurs, which is particularly effective and is preferable in carrying out the process of the instant invention.

Screen openings 3 are structured to have a shape of long holes, as shown, e.g., in somewhat more detail in FIG. 2. These openings 3 are formed to have a hole width W between 1 and 8 mm and a hole length L between 1 and 50 mm. Hole length L is advantageously at least twice hole width W. Another important measurement can also be a spacing A between adjacent screen openings 3 in a direction of their longitudinal extension. In this regard, spacings or distances of between 1 and 6 mm are particularly favorable here, since they are small enough to still render possible a sufficiently large open screen surface and large enough to prevent long fiber spinning at cross-pieces of screen 1. As already stated, the shape and size of such screen openings should be adapted to the purpose, whereby it has been shown that the given measurement ranges provide optimal results in carrying out the process.

It has been ascertained that it is particularly suitable for the inventive process to form screen 1 as a screen basket in which the longitudinal extension of the long holes (screen openings 3) is oriented at an angle a to axial direction 7 of the screen basket that is much greater than 0°, and preferably greater than 450. Moreover, the exemplary embodiment of FIGS. 1 and 2 depict screen openings oriented at an angle a of 90°.

According to FIG. 3, an alignment of long holes 3 can also be defined with regard to the scraper movement. In particular, this exemplary embodiment shows the longitudinal extension of long holes 3 oriented at angle β of, e.g., 30°, to movement direction 5 of scraper 4. With the exemplary embodiments of FIGS. 1 and 2, the longitudinal extension of the long holes is aligned parallel to movement direction 5 of scrapers 4 (i.e., β=0), since the scrapers are usually moved at right angles (i.e., α=90°) to axial direction 7 of the screen basket. If the process is carried out in this manner, a relatively high portion of long fibers gets into accepted stock A. Thus, the good separation effect of the wet screening that can be achieved is due to the fact that alignment, size and shape of the screen openings are optimally adapted to the requirements of a wet screening of fibrous stock.

In implementing the present invention, it is noted that flat screens can also be used as are usual, e.g., in correspondingly formed or embodied screening devices. Secondary pulpers and pulper dump machines are also conceivable uses. German Patent Application No. DE 23 45 735 shows an example of a secondary pulper, and the disclosure of this document is expressly incorporated by reference in its entirety.

It is also known to profile the screen surface such that eddies are produced in the intake area, which eddies help to keep the screen clear. Exemplary embodiment:

Contaminated cardboard was slushed to a suspension with a consistency of approx. 3.5% to form paper fiber stock. This paper fiber stock was then screened in a pressurized screen with the aid of the process according to the invention. The cylindrical screen basket used in the screen was provided with long holes, the width W of which was 1.5 mm and the length L was 4 mm. Their longitudinal extension lay in the circumferential direction (i.e., β=0) and was parallel to scraper movement 5. The values thereby measured were compared with those obtained using a round-hole screen basket with a 1.4 mm perforation, i.e., a perforation whose diameter corresponds approximately to a screen width of the screen basket used according to the invention.

It was thereby ascertained that the throughput relative to the gross surface could be almost doubled with the new process. A higher volumetric throughput is a strong economic argument. At the same time the normally undesirable thickening of reject R could be reduced from a factor of 1.6 to a factor of 1.2 to 1.25. This is partially due to the fact that with the new process the portion of long fibers in the reject could be reduced by 40%. This shows another advantage of the process: more long fibers can remain in accept A, which substantially increases the quality of the cleaned paper fiber stock. Despite these improvements in cost-effectiveness, no significant deterioration in the screening effect, i.e., the elimination of contaminants, was detected.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A process for wet screening fibrous suspensions with a screen having a plurality of screen openings, the process comprising:
guiding a portion of the fibrous suspension passing through the plurality of screen openings, which are formed as long holes having widths of between 1 and 8 mm, as accepted stock; and
guiding a portion of the fibrous suspension not passing through the long holes separately from the accepted stock as rejected material.

2. The process in accordance with claim 1, wherein the widths of the long holes are between 1 and 3 mm.

3. The process in accordance with claim 2, wherein the widths are at least 1.5 mm.

4. The process in accordance with claim 1, wherein the long holes have a length of between 1 and 50 mm.

5. The process in accordance with claim 4, wherein the length is between 2 and 5 mm.

6. The process in accordance with claim 1, wherein a ratio of hole length to hole width is between 2 and 20.

7. The process in accordance with claim 6, wherein the ratio is between 2 and 10.

8. The process in accordance with claim 1, wherein a spacing between adjacent long holes in a direction of longitudinal extension is between 1 and 6 mm.

9. The process in accordance with claim 1, further comprising clearing the screen by moving a scraper past the screen.

10. The process in accordance with claim 9, wherein the scraper is moved in a direction so that an angle between a longitudinal direction of the long holes and the scraper moving direction is between 0 and 75°.

11. The process in accordance with claim 1, wherein the screen is formed as a cylindrical screen basket.

12. The process in accordance with claim 11, wherein the longitudinal extension direction of the long holes is oriented at an angle between 15° and 90° to an axial direction of the screen basket.

13. The process in accordance with claim 12, wherein the angle is larger than 45°.

14. The process in accordance with claim 13, wherein the angle is 90°.

15. The process in accordance with claim 1, wherein the fibrous suspension has a consistency of at least 2%.

16. The process in accordance with claim 15, wherein the fibrous suspension consistency is at least 3%.

17. The process in accordance with claim 1, wherein the fibrous suspension comprises a content of screenable contaminants of at least 0.3%.

18. The process in accordance with claim 17, wherein the screenable contaminants content is at least 0.5%.

19. The process in accordance with claim 1, wherein the fibrous suspension comprises slushed recovered paper.

20. The process in accordance with claim 1, wherein the screen is structured and arranged as a pressurized screen.

21. The process in accordance with claim 1, wherein a plurality of screens are arranged to screen the fibrous suspension and at least one of the plurality of screens is structured and arranged as a pressure screen.

22. The process in accordance with claim 20, wherein the rejected material comprises a suspension enriched with contaminants, and the process further comprises removing the rejected material from the pressurized screen.

23. An apparatus for wet screening fibrous suspensions comprising:
at least one screen formed with a plurality of elongated holes having a length greater than a width;
said at least one screen being arranged to separate accepted portions of the fibrous suspension passing through said at least one screen from rejected materials not passing through said at least one screen,
wherein the width of said elongated holes is between 1 and 8 mm.

24. The apparatus in accordance with claim 23, further comprising a scraper arranged for movement adjacent an inlet side of said at least one screen.

25. The apparatus in accordance with claim 24, wherein a longitudinal extent of said elongated holes are oriented at an angle between 0 and 75° to a moving direction of said scraper.

26. The apparatus in accordance with claim 23, wherein said screen is formed as a cylindrical screen basket.

27. The apparatus in accordance with claim 26, wherein a longitudinal extension of said elongated holes is oriented at an angle between 15° and 90° to an axial direction of said screen basket.

28. The apparatus in accordance with claim 27, wherein the angle is larger than 45°.

29. The apparatus in accordance with claim 28, wherein the angle is 90°.

30. The apparatus in accordance with claim 23, wherein the widths of the elongated holes are between 1 and 3 mm.

31. The apparatus in accordance with claim 30, wherein the widths are at least 1.5 mm.

32. The apparatus in accordance with claim 23, wherein the elongated holes have a length of between 1 and 50 mm.

33. The apparatus in accordance with claim 32, wherein the length is between 2 and 5 mm.

34. The apparatus in accordance with claim 23, wherein a ratio of hole length to hole width is between 2 and 20.

35. The apparatus in accordance with claim 34, wherein the ratio is between 2 and 10.

36. The apparatus in accordance with claim 23, wherein a spacing between adjacent elongated holes in a direction of longitudinal extension is between 1 and 6 mm.

37. The apparatus in accordance with claim 23, wherein said at least one screen is structured and arranged as a pressurized screen.
